(19) United States
(12) Patent Application Publication
(10) Pub. No.: US 2007/0294353 A1
(43) Pub. Date: Dec. 20, 2007

(54) Apparatus, Method and Program Product for Limiting Distribution of E-Mail

(76) Inventors: Laurence Victor Marks, Raleigh, NC (US); Wesley Joseph Miller, Charlotte, NC (US)

Correspondence Address: IBM CORPORATION, PO BOX 12195, DEPT YXSA, BLDG 002, RESEARCH TRIANGLE PARK, NC, 27709, US

(21) Appl. No.: 11/423,987

(22) Filed: Jun. 14, 2006

(51) Int. Cl. G06F 15/16

(52) U.S. Cl. 709/206

(57) ABSTRACT

An e-mail software program is provided with an exclusionary function which removes the name of a sender from a list including the sender before forwarding a message received from the sender to others on the list. On receiving an e-mail message, the name of the sender is saved and subsequently deleted from the list of recipients to which the message is forwarded. The function is invoked by activating a button provided in the graphical user interface (GUI) of a recipient computer.

### CROSS-REFERENCE TO RELATED PATENT APPLICATION

The present invention relates to, Published Patent Application (application Ser. No. 09/961,992, filed Sep. 24, 2004), Published No: US2003/0061289. The published application provides apparatus, method and program product which filters one or more addresses from an e-mail distribution list. A Graphical User Interface (GUI) of an e-mail software tool is provided with an exclusion box in which the address to be excluded is entered by the sender. The software tool correlates the e-mail address in the exclusion box with the e-mail distribution list and forwards the messages to non matching e-mail addresses. The Published Application—assigned to the assignee of the present application—is incorporated in its entirety in the present application.

### BACKGROUND OF THE INVENTION

1. Field of the Invention

The present invention relates to electronic mail, hereafter e-mail, in general and more particularly, to functions which filter unnecessary information from e-mails.

2. Prior Art

E-mail has become the premier vehicle to exchange information. They are messages which are generated by users and transmitted electronically between computers connected to communications network, such as the internet, also know as the World Wide Web or private communications network.

Electronic mail or email is a service provided by software running on a computer, which enables one user to communicate with others, by sending information to them. Email software programs (also called mailers, mail clients, or user agents) have evolved over the years to make usage easier, e.g., by providing address books, and to provide additional function, e.g., Multipurpose Internet Mail Extensions (MIME) which supports inclusion of rich text, graphics, sounds, and binary attachments in addition to text mail. MIME is described in internet Request-For-Comments (RFC) 2045 through 2049, which are incorporated herein by reference.

Much email that is generated is not composed of new content. It is responses to email, or forwarded email. It is common to reply to email with comments, or to forward it to other individuals or groups of individuals. Among the earliest of functions to appear in mailers are the Forward, and Reply functions. Invoking the Forward function generates a new email document, with the body initially filled with the mail item in focus when forward was selected, often with quotation indicators—for example, greater than (>) symbols preceding each line. The Reply function is similar, except that additionally the delivery target (To) field is filled in with the sender (From) of the original mail item.

Another useful function found in many mailers is that of an address book that supports groups. Email addresses are complex, and mail systems are intolerant of errors, so intolerant that minor errors in the address will cause the mail to be returned (undelivered) to sender. To ease the burden on users, mailers often have address books in which the user can insert complicated addresses and short nicknames for them. Some address books additionally support groups, wherein a user can identify a group by its assigned name, and the mail item under preparation will thus be directed to the email addresses of every member of the group.

Although these functions work well for their intended purposes, there is one problem associated with them. If a user receives a mail item that must be forwarded to a group, from a member of that group, it will go to all members, including the sender if an abbreviated name for the group is used. There are times such as forwarding family news just received from one family member, when that is not desirable. In addition, forwarding unnecessary information consumes bandwidth and other resources which are usually scarce commodities and should be preserved.

### SUMMARY OF THE INVENTION

Accordingly, there is a long-felt need for a new email program function, to forward an email to all members of a group except the sender of the mail item to be forwarded.

In addition, there is a need for a function that allows a recipient of an e-mail to use a group name, alias name, nickname or the like to forward the e-mail to members of the group excluding the sender of the e-mail, if said sender of the e-mail is a member of the group.

The present invention provides an apparatus, method and program product that inhibits the forwarding of e-mail to the original sender. A button labeled “Forward Except Sender,” is provided in one of the panels of the GUI. When activated by an user, the identity, such as an e-mail address, of the sender of the original mail, item is retained. As individuals or groups are added to the forwarded mail item the identity is removed from the list of recipients. As a consequence the original mail item is distributed without sending a copy to the original sender even if he is a member of the group selected for distribution.

Another feature of the present invention extends the original sender's identity to include multiple e-mail addresses. In particular, if an individual has multiple e-mail addresses in the address book, mail received from that e-mail address of that individual is not forwarded to any of his addresses when the invention is practiced.

### BRIEF DESCRIPTION OF THE DRAWINGS

The invention is better understood by reading the following detailed description of the preferred embodiment in conjunction with the accompanying drawings, wherein:

FIG. 1 shows a computer network with a computing device executing a mailer with the exclusionary function according to the teachings of the present invention.

FIG. 2 depicts the address book of a mail agent.

FIG. 3 depicts an individual address entry in a mail agent address book.

FIG. 4 depicts a mail message in the inbox view of a mail agent.

FIG. 5 depicts a mail agent forwarding a mail item.

FIG. 6 depicts a mail agent after sending a forwarded item.

FIG. 7 depicts a mail agent with added function to forward an item excluding the original sender.

FIG. 8 depicts the results of forwarding the mail item shown in FIG. 7, using the added function according to teachings of the present invention.

FIG. 9 depicts the address book mode in an enhanced mail agent.

FIG. 10 is a flow chart depicting actions taken when the “Forward except Sender” function button, 700, is selected.

FIG. 11 is a flow chart depicting actions as each recipient address or group is added to the mail item to be forwarded.

### DETAILED DESCRIPTION OF THE PREFERRED EMBODIMENT

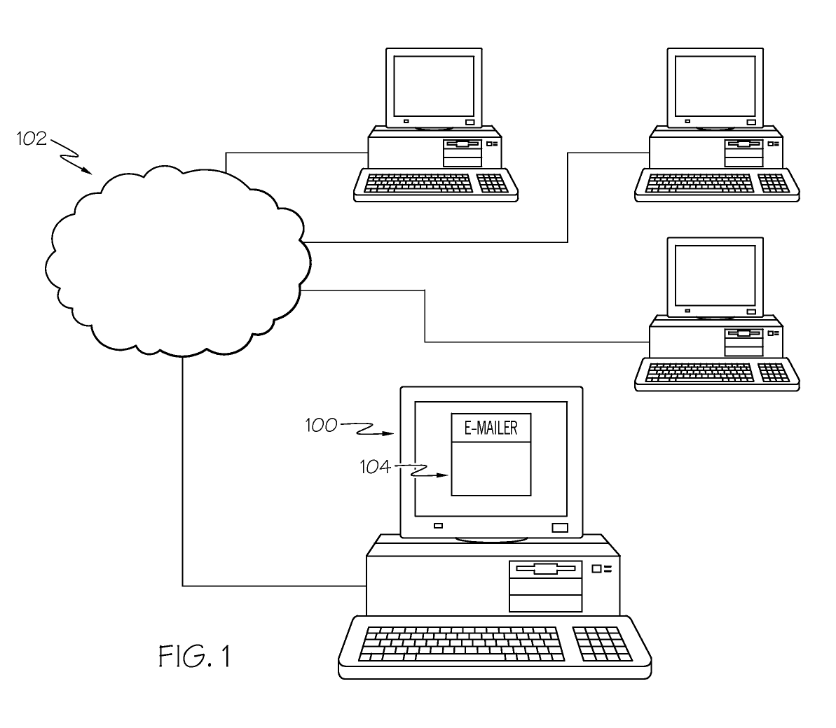

The problem solved by the invention is best understood by analyzing a scenario which occurs with current mail agents. FIG. 1 depicts a computing device, 100, which is connected to other such devices via a network, 102. The network may include nodes such as POP3 and SMTP servers (not shown but well known in the art) to assist in the storage and forwarding of mail items. POP3 and SMTP are described in internet Requests-for-Comments (RFC) 1939 and 2821, incorporated herein by reference. Computing device 100 is executing mail agent 104. Block diagrams of the servers and computing devices also termed, data processing system are set forth in the above identified published patent application and incorporated herein by reference. Computing device 100 is shown as a table top model but laptop or portable models such as ThinkPad® developed and marketed by IBM Corporation could also be incorporated in the network. In addition, wired communication, wireless communication, or both could be practiced in the network.

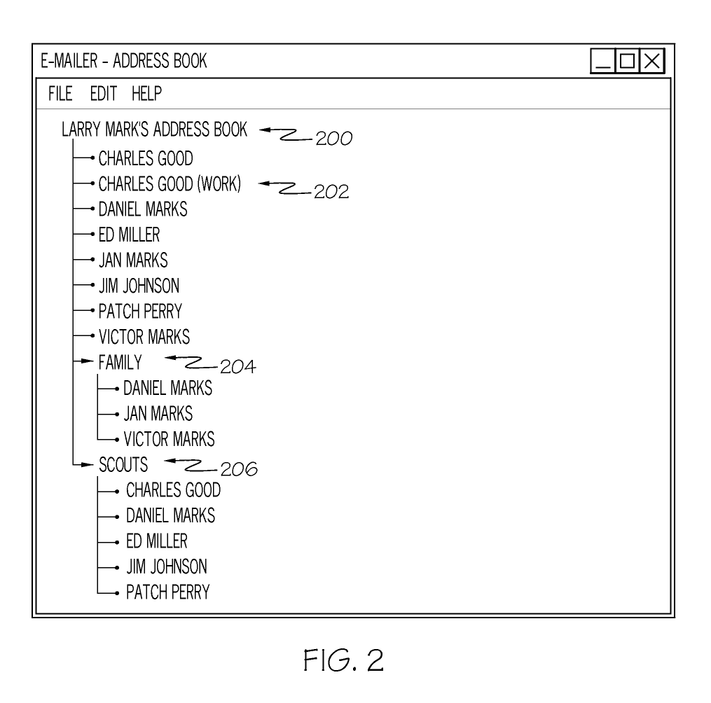

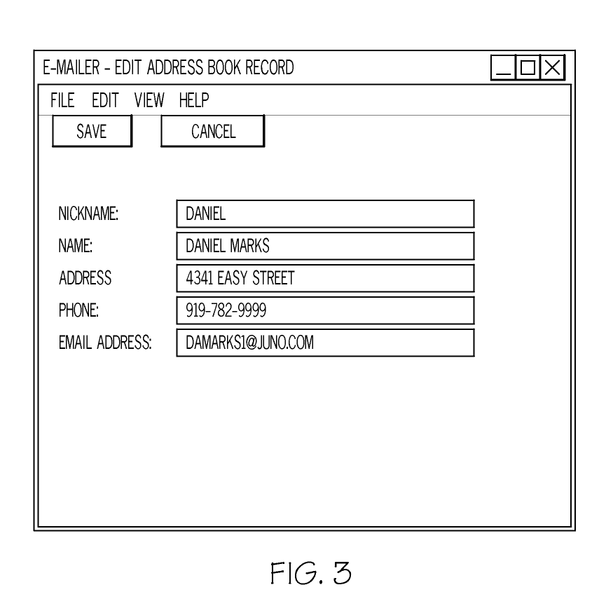

In this scenario, the user's address book, as shown in FIG. 2, contains a list, 200, of individual users, 202, and groups, 204 and 206. The user may add new names or modify existing entries. A panel, such as that shown in FIG. 3, is provided for that purpose in the Graphical User Interface (GUI).

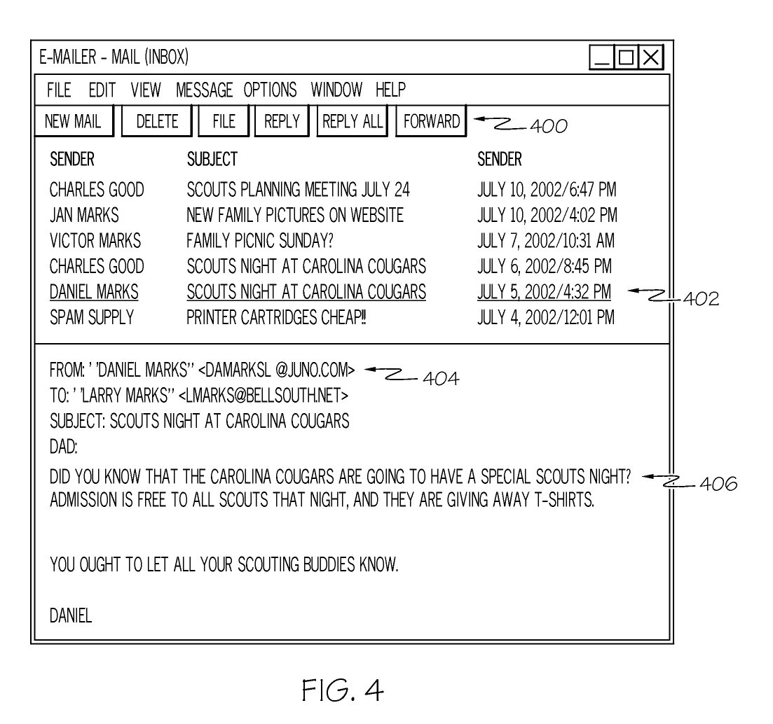

Received mail is shown, in an Inbox view, in FIG. 4. There are a series of function buttons, 400, to permit the user to create new mail, or delete, file or forward a mail item. The latter three buttons each provide a means to transmit the mail item. Reply prepares the item for forwarding to the original sender. Reply All prepares the item for forwarding to the sender and all other recipients. Forward prepares the message for forwarding, but does not automatically fill in any recipients' addresses. These function buttons are provided on current computer GUI and will not be discussed further. Suffice it to say some of these function buttons are used in combination with the present invention. The list portion of the inbox, 402, shows data pertaining to the mail items it contains. The underlined item in the list view is more completely shown in the mail panel, 406. In the example scenario, the user selects Forward, 400, to send the message to a group of individuals. In this case, the user would like to forward the message to all members of the address book group “Scouts” 206, as shown in FIG. 2 except the original sender, Daniel Marks, 404. There is no need for the original sender to receive this information again. Doing so would unnecessarily consume bandwidth and possibly annoy the original sender.

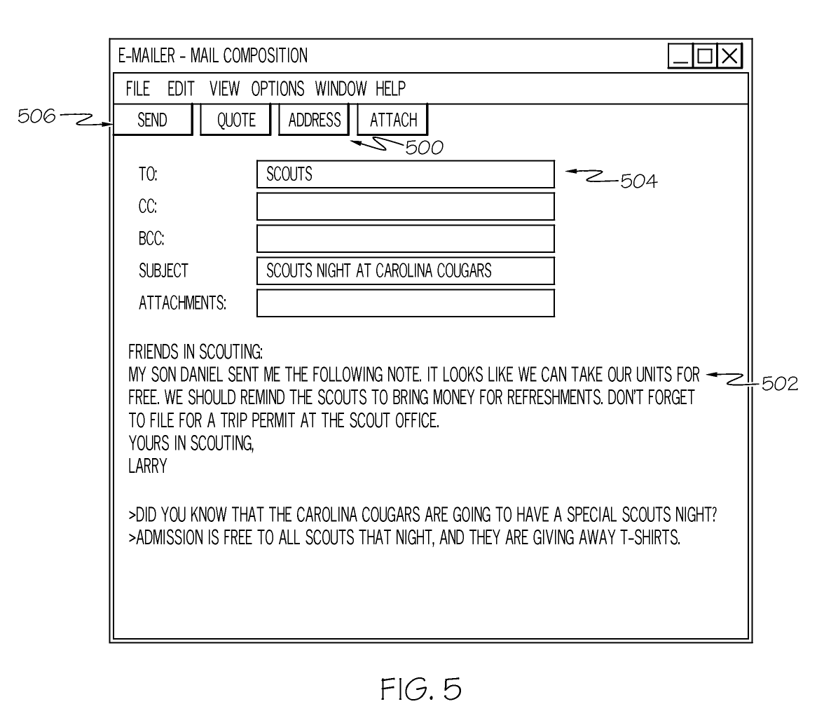

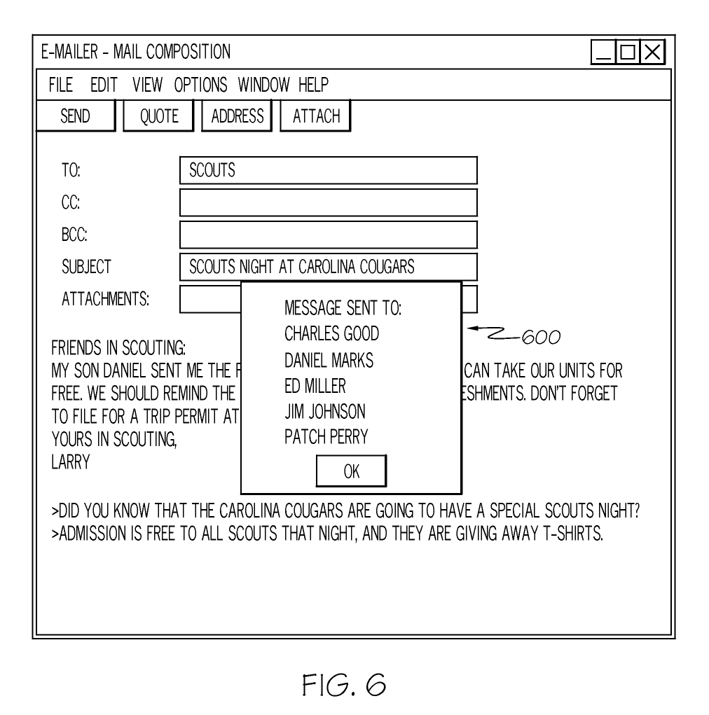

The item is prepared for forwarding, as shown in FIG. 5. The user can add additional information to the mail body, 502. He can indicate recipient individuals or groups by inserting their identifiers directly in the To: field, 504, or by selecting Address function button 500 and selecting them from the Address Book, as shown in FIG. 2. In this example, To: field 504 indicates that the user has elected to send this message to all members of group “Scouts”, 206. When the mail item is ready to send, the user selects the Send function button, 506, to cause the item to be sent. He is then presented with the acknowledgment screen shown in FIG. 6.

Acknowledgment screen 600 indicates the shortcoming of current mail agents. The message has been sent to all members of group “Scouts” 206 including Daniel Marks, who did not need to receive the information, because the message was sent by Daniel Marks. This example has demonstrated the need for an improved forwarding function.

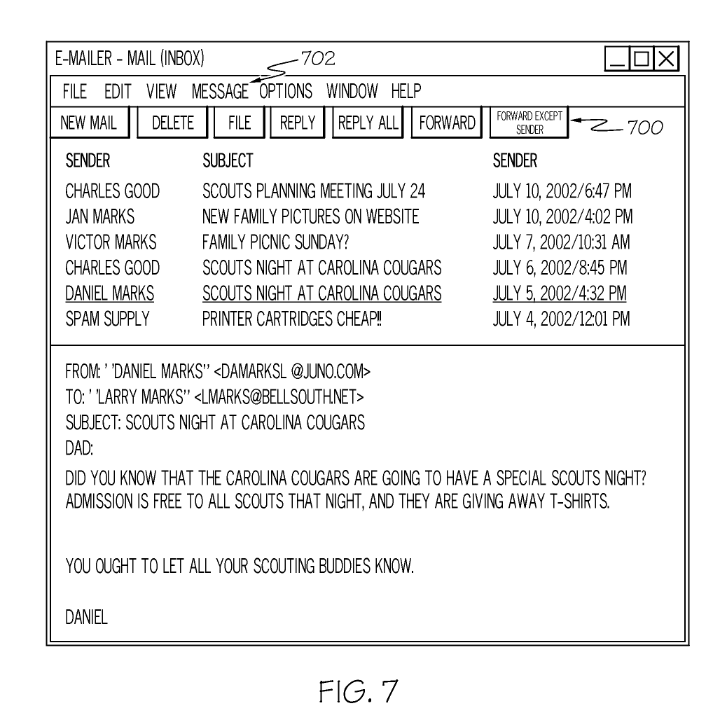

FIG. 7 is an inbox view similar to that shown in FIG. 4, with added function button 700 which provides a function to forward the mail item to diverse recipients but to inhibit forwarding to the original recipient. Although a function button is depicted, this feature is not limited to buttons. It could be invoked as an icon, a pull down (for example, under “Message” action, 702), or via keyboard keystrokes. When this function is invoked, the email address of the sender is stored for later use, and the message is prepared for forwarding. The user is next presented with a screen like that shown in FIG. 5.

The user proceeds to add recipient nicknames or email addresses. Nicknames are expanded to email addresses via recourse to the Address Book. The sender address saved when button 700 was invoked is compared to each recipient address. If the addresses match, that recipient address is removed from the mail item. The comparison preferably takes place as each recipient address is added to the mail item, but could take place when the “Send” function button, 506, is selected.

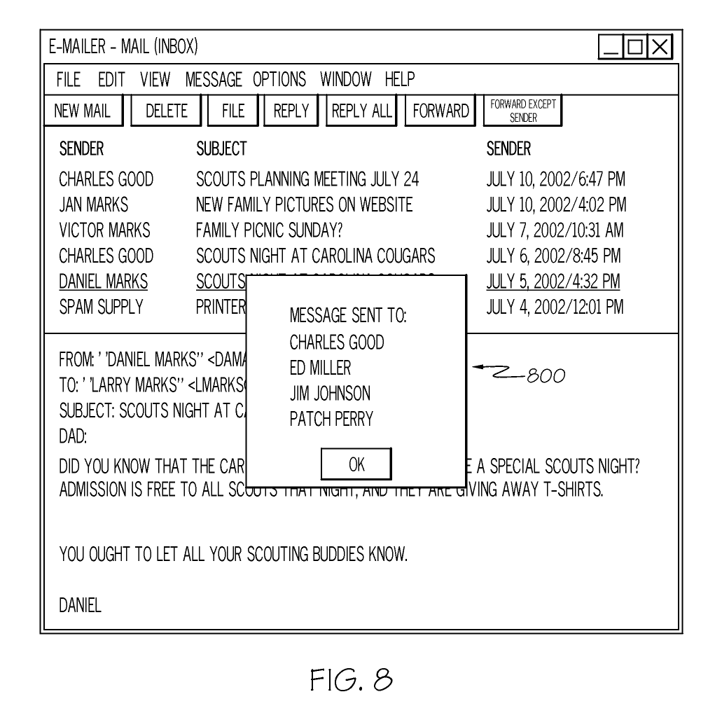

The improvement provided by this added function is shown in FIG. 8. The forwarded mail item is sent to all recipients except Daniel Marks, the sender of the original mail item.

Many individuals use more than one email address. For example, individuals frequently have a personal account and a business account. An additional aspect of the invention avoids forwarding a mail item received from an individual's first account to his second account. The user identifies multiple accounts in the Address Book as belonging to the same individual.

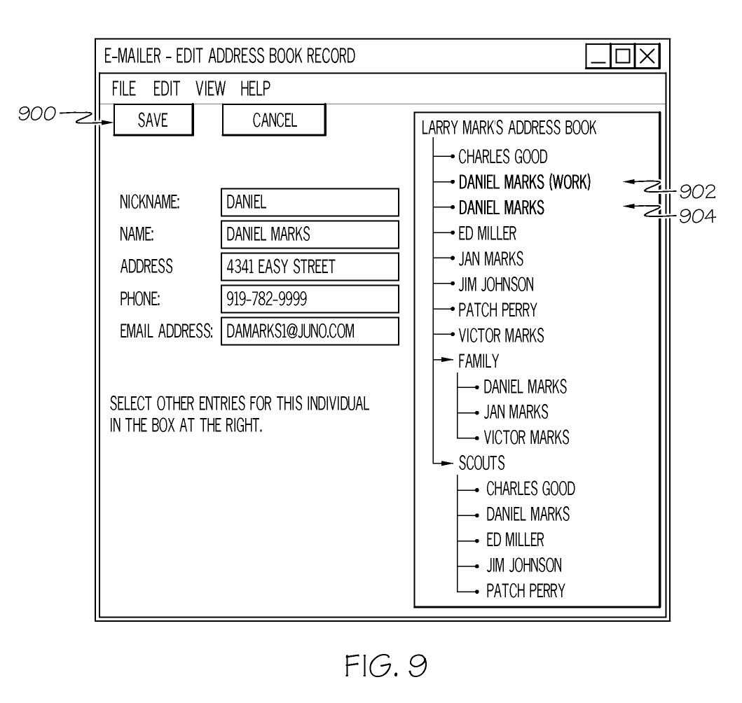

FIG. 9 shows an improved Address Book Entry panel for indicating which email accounts belong to the same individual. The mail user creates separate entries for each email account. He then opens any email account record for the user. The current account, 904, will be highlighted. He highlights the other accounts that belong to the same user (902 in this example) and then selects Save, 900. When an email from this individual is to be forwarded using the invention described herein, mail will not be sent to any of the accounts designated as his. Of course many other user interface techniques could also be used to identify two or more email accounts that are owned by the same individual. For example, with a list of names displayed as shown in FIG. 2, a user could use drag-and-drop to drop associated names on top of one another. Alternatively, with a list such as that of FIG. 2 displayed, a user could right-click (select with pointing device) and cause a context-menu to be displayed. One entry, Associate, would display a name list and allow selection of associated names.

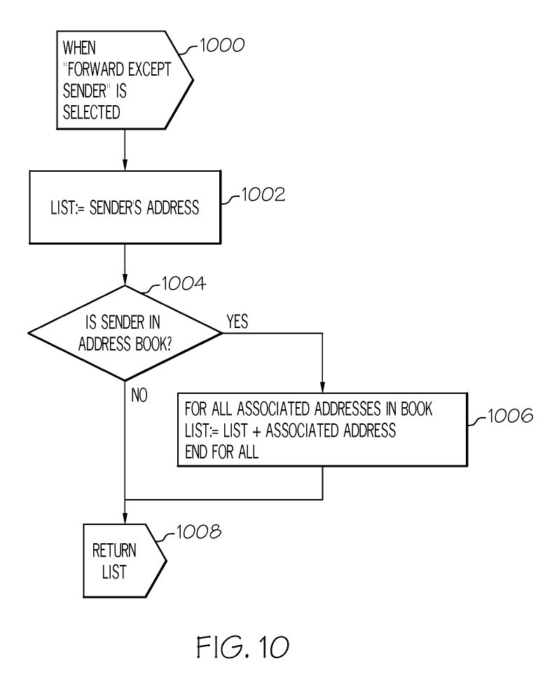

FIG. 10 is a flow chart depicting the actions that are taken when “Forward except sender” button 700 is selected. The sender's identity is saved in a variable called “List.” The routine is entered at step 1000. In step 1002, List receives the sender's email address. In step 1004, the address book is checked to determine whether it contains that address. If not, control is passed to step 1008 and the list (containing the sender's email address only) is returned. If the address book does contain the sender's address, then the List is augmented with all other addresses associated with that individual in step 1006. Then flow is passed to step 1008 and List (containing the sender's email address and all other addresses associated with the sender) is returned. The returned list contains all the e-mail addresses associated with the sender. Once List has been generated, it is accessed each time an additional recipient's name is added.

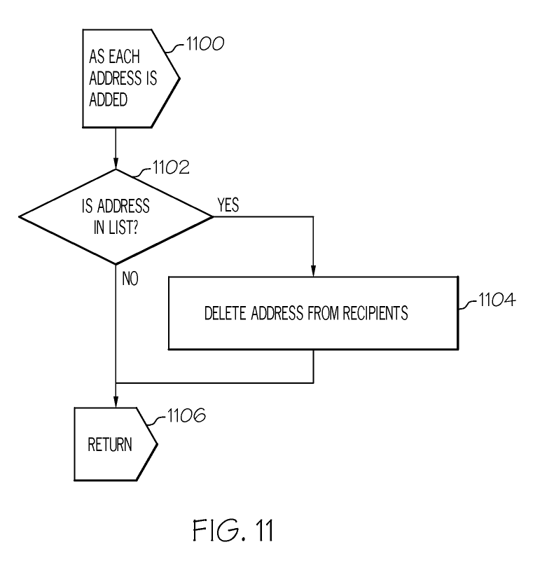

FIG. 11 is a flow chart depicting the actions that are taken as each recipient's name is added to an email created by “Forward except sender” button, 700. This action could also be taken later in the process, e.g., at the time the mail item is sent, but carrying it out at the time each name is added is preferred, because the original sender's name won't appear on screen, confusing the user.

The routine is entered at step 1100 as each address is entered. The address is tested to determine whether it matches any of the names in List, the list of addresses corresponding to the original sender in step 1102. If not, the routine is exited at step 1106. If the recipient address does match any of the addresses corresponding to the original sender, it is deleted from the recipients of the forwarded email at step 1104 and flow continues to step 1106 where the routine is exited.

Even though the invention has been described with respect to a particular illustrative embodiment, it is to be understood that the invention is not limited to details of the above embodiment. Also, modifications can be made by those having ordinary skill in the art without departing from the spirit and scope of the invention set forth in the claims.

What is claimed is:

1. A method of exchanging messages in a computer network comprising:
receiving an e-mail which includes an address;
automatically saving said address from the e-mail;
providing a list of e-mail addresses to which received e-mail is to be forwarded;
correlating the address from the e-mail with the list of e-mail addresses; and
deleting said address if found in said list of e-mail addresses.

2. The method of claim 1 further including forwarding the e-mail to addresses remaining in said list.

3. The method of claim 1 wherein the automatic saving of the address includes activating a button provided in a Graphical User Interface (GUI) of a recipient computer.

4. The method of claim 1 wherein saved e-mail address includes that of the sender of said e-mail.

5. The method of claim 4 wherein automatically saving of the e-mail address includes activating a button provided in a GUI of a computer receiving said e-mail.

6. The method of claim 5 wherein the button is activated by intercepting it with a cursor or other electronic pointer.

7. A program product for distributing e-mail messages in a computer network including a computer readable medium in which a computer program is recorded, said computer program including instruction set, responsive to selection of a predefined button, to extract and save an e-mail address of a sender of an e-mail message;
instruction set which removes the e-mail address of the sender from a list of e-mail addresses; and
instruction set which sends the e-mail message to e-mail addresses remaining in the list.

8. The program product of claim 7 wherein the list is included in an address book residing on a computer receiving said message.

9. The program product of claim 8 further including instruction set which correlates the e-mail address of the sender to identify all incidence of said e-mail address of said sender in said address book; and
instruction set which deletes from said list all incidence of sender address so determined.

10. Apparatus for distributing e-mail messages in a computer network comprising;
a computer which receives the e-mail message operatively coupled to the network;
a predefined button provided in a GUI of said computer, said button causing predefined information to be extracted from the e-mail message;
a memory in which the predefined information is stored; and
a computer program residing on said computer and operable to remove the predefined information from a list.

11. The apparatus of claim 10 wherein the predefined information includes an e-mail address for sender of said e-mail.

12. The apparatus of claim 10 wherein the list includes e-mail addresses.

13. A method comprising:
receiving in a computer an e-mail including a name of a sender;
generating and appending a panel to the e-mail, said panel including at least one field to accommodate routing information;
inserting a group name in said at least one field;
correlating the name of the sender with a list of names associated with the group name;
excluding from the list of names any names matching the name of the sender; and
determining an e-mail address for each entry in a remain list of names.

14. The method of claim 13 wherein the panel is generated by activating a forward button provided in a GUI of the computer.

15. The method of claim 13 further including sending the e-mail to entries in the remaining list of names.
